(19) United States
(12) Patent Application Publication
(10) Pub. No.: US 2015/0117037 A1
(43) Pub. Date: Apr. 30, 2015

(54) LAMP STRUCTURE

(71) Applicant: Lextar Electronics Corporation, Hsinchu (TW)

(72) Inventor: Yueh-Ying FAN, Hsinchu City (TW)

(73) Assignee: Lextar Electronics Corporation, Hsinchu (TW)

(21) Appl. No.: 14/194,823

(22) Filed: Mar. 3, 2014

(30) Foreign Application Priority Data
Oct. 24, 2013 (TW) 102138495

(51) Int. Cl. F21V 23/00

(52) U.S. Cl. CPC F21V 23/005
USPC 362/375; 362/362

(57) ABSTRACT

A lamp structure includes a shell, a light board, at least one light emitting diode, two electrical connecting elements, an electrical terminal, and a driving module. The shell has a first end and a second end opposite to each other. The light board is disposed on the first end of the shell. The light board has two through holes and two conductive portions respectively disposed adjacent to the through holes. The electrical connecting elements are disposed around the through holes and on the light board, and electrically connected to the conductive portions, respectively. The driving module includes a driving circuit and two electrodes. The driving circuit is disposed at a side of the light board opposite to the light emitting diode. The two electrodes are electrically connected to the driving circuit. The two electrodes thread through the two through holes and interfere with the two electrical connecting elements, respectively.

### RELATED APPLICATIONS

This application claims priority to Taiwan Application Serial Number 102138495, filed Oct. 24,2013, which is herein incorporated by reference.

### BACKGROUND

1. Field of Invention

The present invention relates to a lamp structure. More particularly, the present invention relates to an LED lamp structure.

2. Description of Related Art

A general light emitting diode lamp at least includes a light emitting diode, a light board, and a driving module. The light emitting diode and the driving module are respectively disposed at opposite sides of the light board. In general, wires are required between the light emitting diode and the driving module to form electrical connections, where the joint is conducted by bonding with solders. Accordingly, in assembly the wires are respectively guided through two predetermined holes of the light board and then pulled out from the holes to connect to solder pads for the light emitting diode on the light board. The ends of the wires are pressed on the pads and bonded to the pads with solder. This configuration of the wires in the assembly has a weak mechanical structure. Also, the assembly processes are complicated, which incurs more cost of components in the assembly and is disadvantageous to the mass production.

### SUMMARY

An aspect of the present invention provides a lamp structure including a shell, a light board, at least one light emitting diode, two electrical connecting elements, an electrical terminal, and a driving module. The shell has a first end and a second end opposite to the first end. The light board is disposed on the first end of the shell. The light board has two through holes and two conductive portions respectively disposed adjacent to the two through holes. The light emitting diode is disposed on the light board. The electrical connecting elements are respectively disposed around the two through holes and on the light board, and respectively electrically connected to the two conductive portions. The electrical terminal is connected to the second end of the shell and forms an accommodating space with the shell. The driving module is disposed in the accommodating space. The driving module includes a driving circuit and two electrodes. The driving circuit is disposed at a side of the light board opposite to the light emitting diode. The electrodes are electrically connected to the driving circuit and protruding from the driving circuit. The two electrodes thread through the two through holes and interfere with the two electrical connecting elements, respectively.

In one or more embodiments, each of the electrical connecting elements is a spring plate. The spring plate includes a fixing portion and a connecting portion. The fixing portion has an opening therein. The opening exposes the through hole of the light board. The connecting portion extends upwards from the fixing portion to the above of the through hole, and the connecting portion is configured for connecting the electrode.

In one or more embodiments, the shell further has a supporting surface disposed on the first end configured for supporting the light board

In one or more embodiments, the supporting surface has two guiding slots respectively disposed below the two through holes of the light board. The guiding slots are configured for guiding the two electrodes into the two through holes.

In one or more embodiments, each of the guiding slots includes a hole and two inclined chamfered portions. The hole is disposed on the supporting surface and corresponding to the through hole. The inclined chamfered portions are disposed below the supporting surface and disposed at two opposite sides of the hole.

In one or more embodiments, the lamp structure further includes a plurality of hooks disposed at an edge of the first end of the shell. The hooks are configured for fixing the light board.

In one or more embodiments, the lamp structure further includes a lamp cover disposed on the first end of the shell to cover at least the light board, the light emitting diode, and the electrical connecting elements.

In one or more embodiments, the electrical connecting elements are fixed on the light board through a bonding process.

In one or more embodiments, the electrical connecting elements are made of metal.

In one or more embodiments, the conductive portions are bonding pads.

Since the lamp structure in the embodiments mentioned above is assembled by processing the operations of threading the electrodes of the driving module through the shell and the light board, and being respectively electrically connecting the electrodes to the electrical connecting elements. Therefore, the assembly process can be speed up. Furthermore, since the driving module can be electrically connected to the light emitting diode without wires, the structure strength of the lamp structure can be enhanced.

### BRIEF DESCRIPTION OF THE DRAWINGS

FIG. 1 is a perspective diagram of a lamp structure according to one embodiment of the present invention;

FIG. 2 is an exploded view of the lamp structure of FIG. 1;

FIG. 3A is a front view of electrical connecting elements of FIG. 2;

FIG. 3B is a side view of the electrical connecting elements of FIG. 2;

FIG. 4A is a cross sectional view taking along line 4A-4A of FIGS. 1; and

FIG. 4B is a cross sectional view of a driving module and the electrical connecting elements of FIG. 4A when they are separate from each other.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

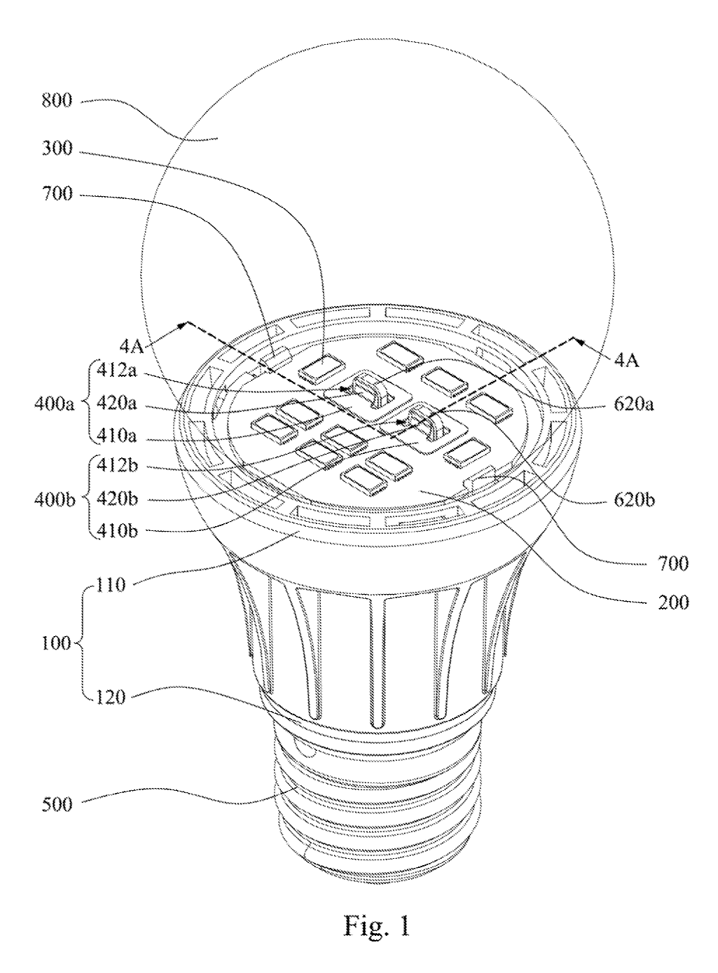

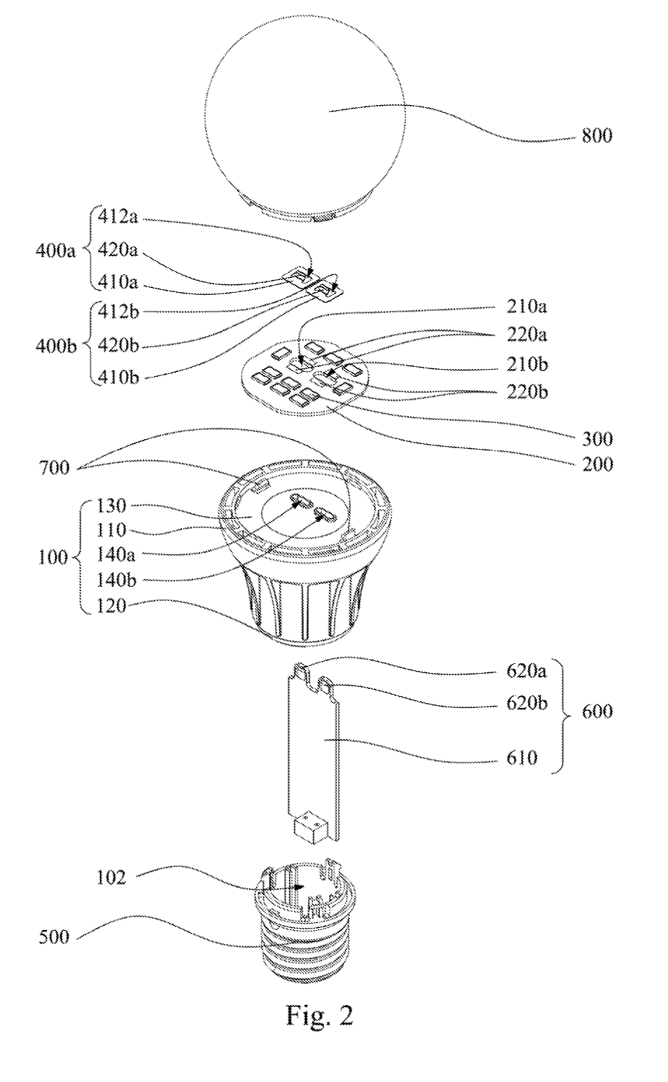

FIG. 1 is a perspective diagram of a lamp structure according to one embodiment of the present invention, and FIG. 2 is an exploded view of the lamp structure of FIG. 1. Reference is made to FIGS. 1 and 2. The lamp structure includes a shell 100, a light board 200, at least one light emitting diode 300, two electrical connecting elements (400a, 400b), an electrical terminal 500, and a driving module 600. The shell 100 has a first end 110 and a second end 120 opposite to each other. The light board 200 can be a circuit substrate, and is disposed on the first end 110 of the shell 100. The light board 200 has two through holes (210a, 210b) and two conductive portions (220a, 220b) respectively disposed adjacent to the two through holes (210a, 210b). The light emitting diode 300 is disposed on the light board 200. The electrical connecting elements (400a, 400b) are respectively disposed around the two through holes (210a, 210b) and on the light board 200, and respectively electrically connected to the two conductive portions (220a, 220b). The electrical terminal 500 is connected to the second end 120 of the shell 100 and forms an accommodating space 102 with the shell 100. The driving module 600 is disposed in the accommodating space 102. The driving module 600 includes a driving circuit 610 and two electrodes (620a, 620b). The driving circuit 610 is disposed at a side of the light board 200 opposite to the light emitting diode 300. The two electrodes (620a, 620b) are electrically connected to the driving circuit 610 and protruding from the driving circuit 610. The two electrodes (620a, 620b) respectively thread through the two through holes (210a, 210b) and respectively interfere with the two electrical connecting elements (400a, 400b) to form electrical connections.

Reference is made to FIG. 2. In this embodiment, the shell 100 further has a supporting surface 130 disposed on the first end 110 and configured for supporting the light board 200. In other words, the light board 200 and the driving circuit 610 of the driving module 600 are respectively disposed at opposite sides of the supporting surface 130. Furthermore, the supporting surface 130 has two guiding slots (140a, 140b) respectively disposed below the two through holes (210a, 210b) of the light board 200. The guiding slots (140a, 140b) are configured for guiding the two electrodes (620a, 620b) into the two through holes (210a, 210b).

Reference is made to FIGS. 1 and 2. The electrical connecting elements (400a, 400b) can be respectively fixed on the conductive portions (220a, 220b) of the light board 200 during the assembly process. Subsequently, the light board 200 can be disposed on the first end 110 of the shell 100. The two electrodes (620a, 620b) of the driving module 600 can thread through the shell 100 and the through holes (210a, 210b) of the light board 200 via the two guiding slots (140a, 140b). Therefore, the electrodes (620a, 620b) can be respectively electrically connected to the electrical connecting elements (400a, 400b). Furthermore, the electrical connecting elements (400a, 400b) are electrically connected to the light emitting diode 300 via the conductive portions (220a, 220b) and the electrical terminal 500 is electrically connected to the driving circuit 610. Therefore, when the electrical terminal 500 transmits external electrical energy to the driving circuit 610 of the driving module 600, the driving module 610 can actuate the light emitting diode 300 on the light board 200 via the two electrodes (620a, 620b), the electrical connecting elements (400a, 400b), and the conductive portions (220a, 220b) in sequence.

The lamp structure is assembled by processing the operations of disposing the light board 200 assembled with the electrical connecting elements (400a, 400b) on the shell 100, threading the electrodes (620a, 620b) of the driving module 600 through the shell 100 and the light board 200, and being respectively electrically connecting the electrodes (620a, 620b) to the electrical connecting elements (400a, 400b). Therefore, the assembly process can be speed up. Furthermore, through the attachment between the electrodes (620a, 620b) and the electrical connecting elements (400a, 400b), the driving module 600 can be electrically connected to the light emitting diode 300 without wires. Hence, the structure strength of the lamp structure can be enhanced.

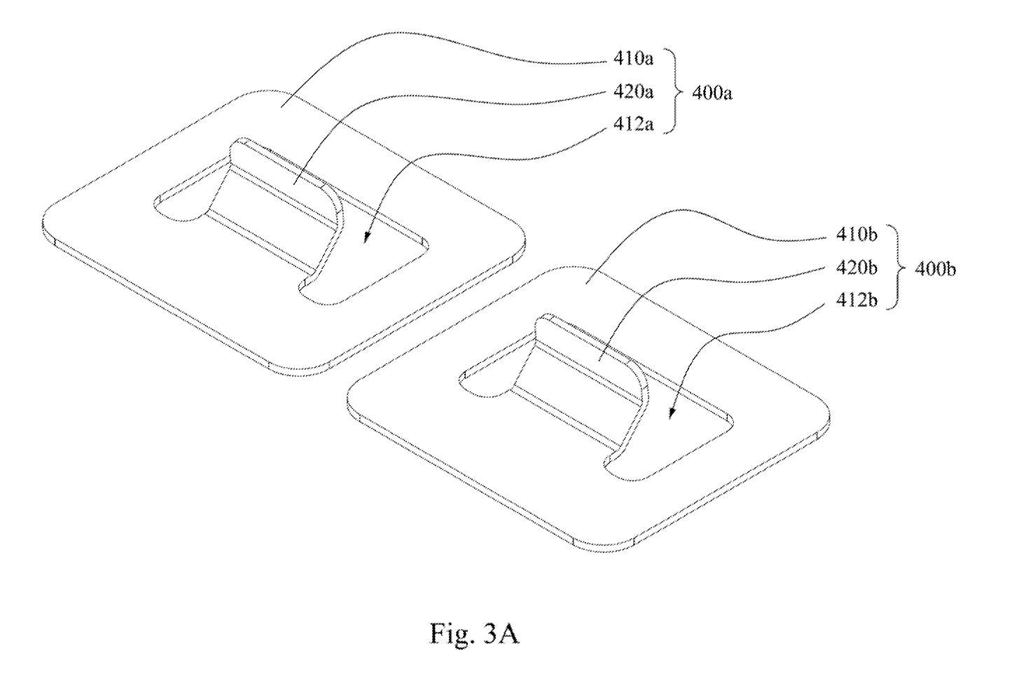

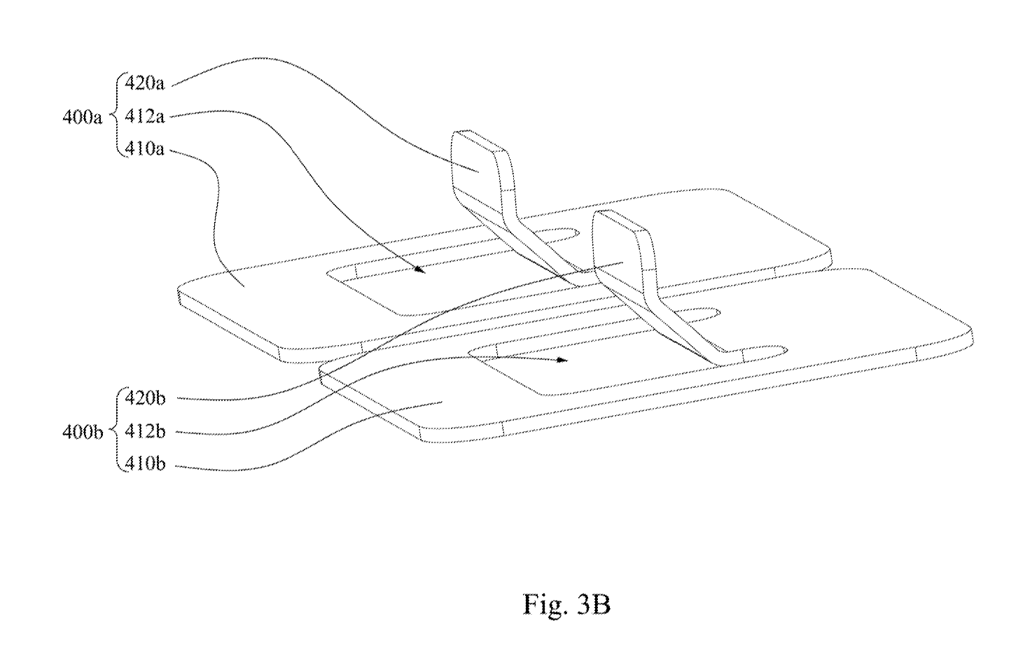

FIG. 3A is a front view of the electrical connecting elements (400a, 400b) of FIG. 2, and FIG. 3B is a side view of the electrical connecting elements (400a, 400b) of FIG. 2. Reference is made to FIGS. 3A and 3B. In this embodiment, each of the electrical connecting elements (400a, 400b) can be a spring plate. More specifically, the electrical connecting element 400a includes a fixing portion 410a and a connecting portion 420a. The fixing portion 410a has an opening 412a therein. The opening 412a exposes the through hole 210a of the light board 200. The connecting portion 420a extends upwards from the fixing portion 410a to the above of the through hole 210a, and the connecting portion 420a is configured for interfering the electrode 620a that threads through the opening 412a. Moreover, the electrical connecting element 400b includes a fixing portion 410b and a connecting portion 420b. The fixing portion 410b has an opening 412b therein. The opening 412b exposes the through hole 210b of the light board 200. The connecting portion 420b extends upwards from the fixing portion 410b to the above of the through hole 210b, and the connecting portion 420b is configured for interfering the electrode 620b that threads through the opening 412b. In greater detail, since the connecting portions (420a, 420b) respectively extend upwards to the above of the through holes (210a, 210b), the electrodes (620a, 620b) can respectively thread through the through holes (210a, 210b) and the openings (412a, 412b) to attach the connecting portions (420a, 420b), such that the electrodes (620a, 620b) can interfere with the connecting portions (420a, 420b), respectively.

Reference is made to FIGS. 2, 3A, and 3B. Due to the elasticity of the spring plate, the connecting portions (420a, 420b) above the through holes (210a, 210b) can be respectively pushed by the electrodes (620a, 620b) after the electrodes (620a, 620b) thread through the openings (412a, 412b) of the electrical connecting elements (400a, 400b). However, the connecting portions (420a, 420b) can respectively tuck the electrodes (620a, 620b) due to their elasticity, such that the connecting portions (420a, 420b) can be respectively electrically connected to the electrodes (620a, 620b). In other words, the electrodes (620a, 620b) can interfere with the connecting portions (420a, 420b) without any further operations after the driving module 600 is inserted to the light board 200. In one or more embodiments, the electrical connecting elements (400a, 400b) can be made of metal. More specifically, metal has conductivity and elasticity. However, the claimed scope of the present invention is not limited in this respect.

Moreover, the electrical connecting elements (400a, 400b) can be fixed on the light board 200 through a bonding process, which is referred to surface-mount technology (SMT). More specifically, since the light emitting diode 300 can be fixed on the light board 200 through the bonding process, the electrical connecting elements (400a, 400b) can also be bonded on the light board 200 during the same bonding process to save the processing time. However, the claimed scope of the present invention is not limited in this respect.

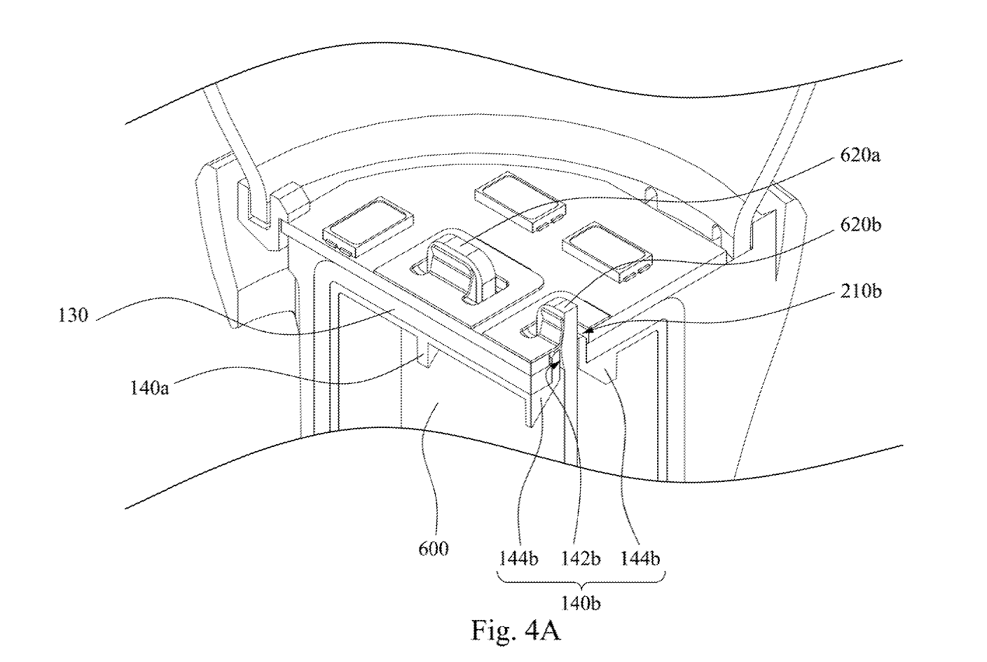

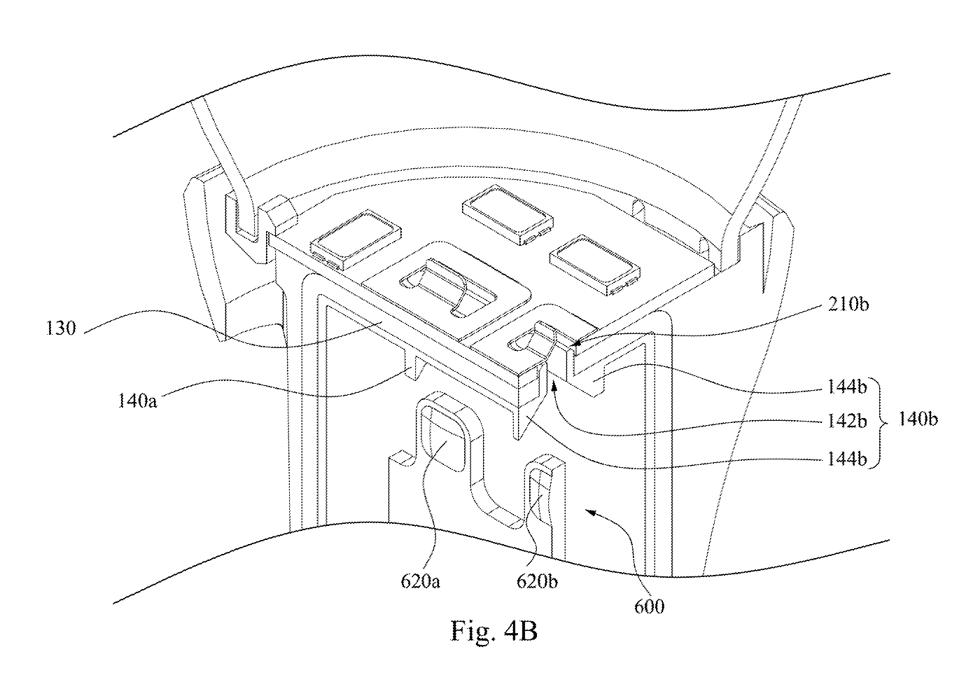

FIG. 4A is a cross sectional view taking along line 4A-4A of FIG. 1, and FIG. 4B is a cross sectional view of the driving module 600 and the electrical connecting elements (400a, 400b) of FIG. 4A when they are separate from each other. Reference is made to FIGS. 4A and 46. In one or more embodiments, each of the guiding slots (140a, 140b) includes a hole and two inclined chamfered portions. Taking the guiding slot 140b as an example, the guiding slot 140b includes a hole 142b and two inclined chamfered portions 144b. The hole 142b is disposed on the supporting surface 130 and corresponding to the through hole 210b. The inclined chamfered portions 144b are disposed below the supporting surface 130 and disposed at two opposite sides of the hole 142b. Since the structure of the guiding slot 140a are the same as that of the guiding slot 140b in FIG. 3, a description in this regard will not be provided hereinafter.

During the assembly process, the electrode 620a of the driving module 600 can touch the inclined chamfered portions of the guiding slot 140a, and the electrode 620b can touch the inclined chamfered portions 144b of the guiding slot 140b, such that the electrodes (620a, 620b) can be respectively guided to the hole of the guiding slot 140a and the hole 142b of the guiding slot 140b. The electrodes (620a, 620b) can respectively directly thread through the through holes (210a, 210b) without alignment after they thread through the supporting surface 130. In other words, the guiding slots (140a, 140b) can be used to align the electrodes (620a, 620b) to the through holes (210a, 210b), and the assembly time of the lamp structure can be further reduced.

Reference is made to FIGS. 1 and 2. In this embodiment, the lamp structure can further include a plurality of hooks 700 disposed at an edge of the first end 110 of the shell 100. The hooks 700 are configured for fixing the light board 200. Taking FIGS. 1 and 2 as an example, the hooks 700 can be respectively disposed at two opposite sides of the edge of the first end 110, such that the hooks 700 can buckle the opposite sides of the light board 200 when the light board 200 is disposed on the supporting surface 130. It should be noted that the number and the positions of the hooks 700 in FIGS. 1 and 2 are illustrative only and should not limit the claimed scope of the present invention. A person having ordinary skill in the art may select proper number and positions of the hooks 700 according to actual requirements.

In this embodiment, the lamp structure can further include a lamp cover 800 disposed on the first end 110 of the shell 100 to cover at least the light board 200, the light emitting diode 300, and the electrical connecting elements (400a, 400b) The light emitted from the light emitting diode 300 can pass through the lamp cover 800 while the lamp cover 800 protects the light emitting diode 300 and other elements.

In this embodiment, the conductive portions (220a, 220b) can be bonding pads. That is, the conductive portions (220a, 220b) can be formed during the layout process of the light board 200. As such, the conductive portions (220a, 220b) can be formed without further process to save the whole manufacturing time. In addition, the conductive portions (220a, 220b) can be plural, respectively, according to real requirements. Taking FIG. 2 as an example, the numbers of the conductive portions (220a, 220b) are both two. Basically, an embodiment falls within the scope of the claimed invention if the conductive portions (220a, 220b) can be electrically connecting to the light emitting diode 300 and the electrical connecting elements (400a, 400b).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A lamp structure, comprising:
a shell having a first end and a second end opposite to each other;
a light board disposed on the first end of the shell, the light board having two through holes and two conductive portions respectively disposed adjacent to the two through holes;
at least one light emitting diode disposed on the light board;
two electrical connecting elements respectively disposed around the two through holes and on the light board, and respectively electrically connected to the two conductive portions;
an electrical terminal connected to the second end of the shell and forming an accommodating space with the shell; and
a driving module disposed in the accommodating space, the driving module comprising:
a driving circuit disposed at a side of the light board opposite to the light emitting diode; and
two electrodes electrically connected to the driving circuit and protruding from the driving circuit, wherein the two electrodes thread through the two through holes and interfere with the two electrical connecting elements, respectively.

2. The lamp structure of claim 1, wherein each of the electrical connecting elements is a spring plate comprising:
a fixing portion having an opening therein, the opening exposing the through hole of the light board; and
a connecting portion extending upwards from the fixing portion to the above of the through hole, and the connecting portion configured for connecting the electrode.

3. The lamp structure of claim 1, wherein the shell further has a supporting surface disposed on the first end configured for supporting the light board.

4. The lamp structure of claim 3, wherein the supporting surface has two guiding slots respectively disposed below the two through holes of the light board, wherein the guiding slots are configured for guiding the two electrodes into the two through holes.

5. The lamp structure of claim 4, wherein each of the guiding slots comprises:
a hole disposed on the supporting surface and corresponding to the through hole; and
two inclined chamfered portions disposed below the supporting surface and disposed at two opposite sides of the hole.

6. The lamp structure of claim 1, further comprising a plurality of hooks disposed at an edge of the first end of the shell, the hooks configured for fixing the light board.

7. The lamp structure of claim 1, further comprising:
a lamp cover disposed on the first end of the shell to cover at least the light board, the light emitting diode, and the electrical connecting elements.

8. The lamp structure of claim 1, wherein the electrical connecting elements are fixed on the light board through a bonding process.

9. The lamp structure of claim 1, wherein the electrical connecting elements are made of metal.

10. The lamp structure of claim 1, wherein the conductive portions are bonding pads.
